(19) United States
(12) Patent Application Publication
(10) Pub. No.: US 2004/0175302 A1
(43) Pub. Date: Sep. 9, 2004

(54) Preparation of sorbent for SO2 Scrubber system

(75) Inventors: Wayne S. Counterman, Wellsville, NY (US); Shin G. Kang, Simsbury, CT (US); Srivats Srinivasachar, Sturbridge, MA (US)

Correspondence Address: ALSTOM Power Inc., 2000 Day Hill Road, Windsor, CT, 06095, US

(73) Assignee: ALSTOM (Switzerland) Ltd

(21) Appl. No.: 10/383,935

(22) Filed: Mar. 7, 2003

(51) Int. Cl. B01D 50/00

(52) U.S. Cl. 422/172; 422/170; 422/169; 422/171

(57) ABSTRACT

A sorbent addition system for a steam generator system having a boiler, an air preheater, a scrubber, an air duct providing fluid communication between the air preheater and the boiler, a first flue gas duct providing fluid communication between the boiler and the air preheater, and a second flue gas duct providing fluid communication between the air preheater and the scrubber. The sorbent addition system comprises a calciner having a calciner exhaust which provides fluid communication with either the first or second flue gas ducts. A limestone addition subsystem and a fuel addition subsystem are in fluid communication with the calciner.

### BACKGROUND OF THE INVENTION

This invention relates generally to a steam generating system having a boiler producing flue gas carrying SO₂ and/or SO₃. More particularly, the present invention relates to a steam generating system using lime to remove SO₂ and/or SO₃ from the flue gas produced by a boiler.

During the combustion process in the boiler, the sulfur in the fuel is oxidized to SO₂. After the combustion process, some amount of SO₂ is further oxidized to SO₃, with typical amounts on the order of 1 to 2% going to SO₃. The presence of iron oxide, vanadium and other metals at the proper temperature range produces this oxidation. Selective catalytic reduction (SCR) are also widely known to oxidize a portion of the SO₂ in the flue gas to SO₃. The catalyst formulation (primarily the amount of vanadium in catalyst) impacts the amount of oxidation, with rates ranging from 0.5% to over 1.5%. Most typical is around 1%. Therefore plants firing a high sulfur coal with a new SCR can see a large increase in the SO₃ emissions, which produce a visible plume, local acidic ground level problems and other environmental issues.

Dry or semi-dry SO₂ scrubbing systems such as a flash dryer absorber (FDA) use lime (CaO) as sorbent. If lime is used as a sorbent in wet scrubbers scrubber size and pressure drop can be significantly lowered. The lime used by the power plant can be purchased from an external supplier (“commercial lime”) at a cost of $60-80/ton. Alternatively, lime can be generated within the furnace/boiler (“boiler-generated lime”) from limestone (CaCO₃) injected into the boiler through the existing pulverizer, with the lime ending up in the fly ash used in the scrubber. Accordingly, minimal additional equipment is required for such lime generation. The limestone costs $10-20/ton ($18-36 per equivalent ton of lime).

However, about 15-20% of the boiler-generated lime is retained by the boiler as “bottom ash”, thereby reducing the quantity of lime in the flue gas stream. In addition, the activity of the “boiler-generated” lime is typically lower than “commercial” lime with respect to SO₂ removal capability-on the order of about 60-80%. One reason is “boiler-generated” lime is subjected to higher temperatures in the furnace compared to “commercial” lime during calcining, which results in loss of surface area. Another reason is that “boiler-generated” lime is sulfated to a small extent (about 5%) by SO₂ in the primary combustion gases, while commercial lime is sulfate-free. Consequently, the Ca/S molar ratio needed in the case of “boiler-generated” lime compared to “commercial” lime would be about 1.5 to 2 times higher.

In addition, injection of limestone in the boiler can lead to deposition in the furnace (slagging) or in the convective section (fouling). Increased slagging can occur in the lower furnace especially with high-iron ash coals. Fouling occurs because the lime (CaO) recarbonates and sulfates while resident on the heat transfer surfaces, leading to deposit buildup and sintering. Increased deposit removal (sootblowing and, or sonic cleaning) is required with boiler injection of limestone. This could mean installation of additional blowers to get better coverage and definitely means increased frequency of blowing (operational cost), or, as an alternative, adjunct installation of sonic cleaners.

One location where increased fouling can take place is in the economizer section, especially, if it has a staggered, finned design. Fouling would be lower with in-line economizer designs and bare tube designs. Consequently, the increased fouling tendency may require a costly economizer change-out to replace the more “aggressive” staggered, finned heat transfer surface design with a less “aggressive” bare tube design.

In cases where the evaluated capital and operational costs of “boiler-generated” lime approach is greater that for “commercial” lime, the impetus for injection of limestone in the boiler is significantly lowered.

### SUMMARY OF THE INVENTION

Briefly stated, the invention in a preferred form is a sorbent addition system for a steam generator system having a boiler, an air preheater, a scrubber, an air duct providing fluid communication between the air preheater and the boiler, a first flue gas duct providing fluid communication between the boiler and the air preheater, and a second flue gas duct providing fluid communication between the air preheater and the scrubber. The sorbent addition system comprises a calciner having a calciner exhaust which provides fluid communication with either the first or second flue gas ducts. A limestone addition subsystem and a fuel addition subsystem are in fluid communication with the calciner.

An air inlet duct provides a supply of hot combustion air from the air duct of the steam generator system to the calciner. A particulate separator device may be disposed in the calciner exhaust.

The limestone addition subsystem includes a pulverizer in fluid communication with the calciner and a bulk limestone storage and metering device in fluid communication with the pulverizer. A bulk limestone receiving device deposits the bulk limestone in the bulk limestone storage and metering device. A pulverized material storage and metering device may be disposed intermediate the pulverizer and the calciner. The fuel addition subsystem may include a bulk coal storage and metering device in fluid communication with the pulverizer.

A controller is in electrical communication with the limestone addition subsystem and the fuel addition subsystem. Specifically, the controller is in electrical communication with the bulk limestone storage and metering device, the pulverized material storage and metering device, and the bulk coal storage and metering device. A temperature sensor in the calciner exhaust provides a temperature signal to the controller. If an exhauster fan is installed in the air inlet duct, the exhauster fan is controlled by the controller.

It is an object of the invention to generate “virgin” lime that has SO₂ capturing properties that are superior to “boiler-generated” lime and equivalent or superior to “commercial” lime.

It is also an object of the invention to generate “virgin” lime without the deposition of such lime as ash in the boiler.

It is further an object of the invention to recover heat from the calcination process gases in an economical fashion using in-place equipment.

It is still further an object of the invention to reduce the amount of fouling in the air preheater to increase time between water washings, to allow operation at lower temperatures thereby improving boiler efficiency, or to deliberately condense more SO₃ in a regenerative air preheater to improve plant opacity and reduce stack SO₃ content.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is a schematic diagram of a sorbent addition system in accordance with the subject invention;

FIG. 2 is a schematic diagram of a first embodiment of a steam generator system including the sorbent addition system of FIG. 1;

FIG. 3 is a schematic diagram of a second embodiment of a steam generator system including the sorbent addition system of FIG. 1; and

FIG. 4 is a schematic diagram of a third embodiment of a steam generator system including the sorbent addition system of FIG. 1;

### DETAILED DESCRIPTION OF THE PREFERRED EMBODIMENT

The apparatus described below may be used with any steam generator system having flue gas from which sulfur must be removed. However, for the purposes of illustration, the subject invention is discussed as being installed on a 100 Mwe coal-fired steam generator system. For a 100 Mwe coal-fired unit with 2.5% sulfur in the boiler fuel, limestone requirements are about 4 tons/hr.

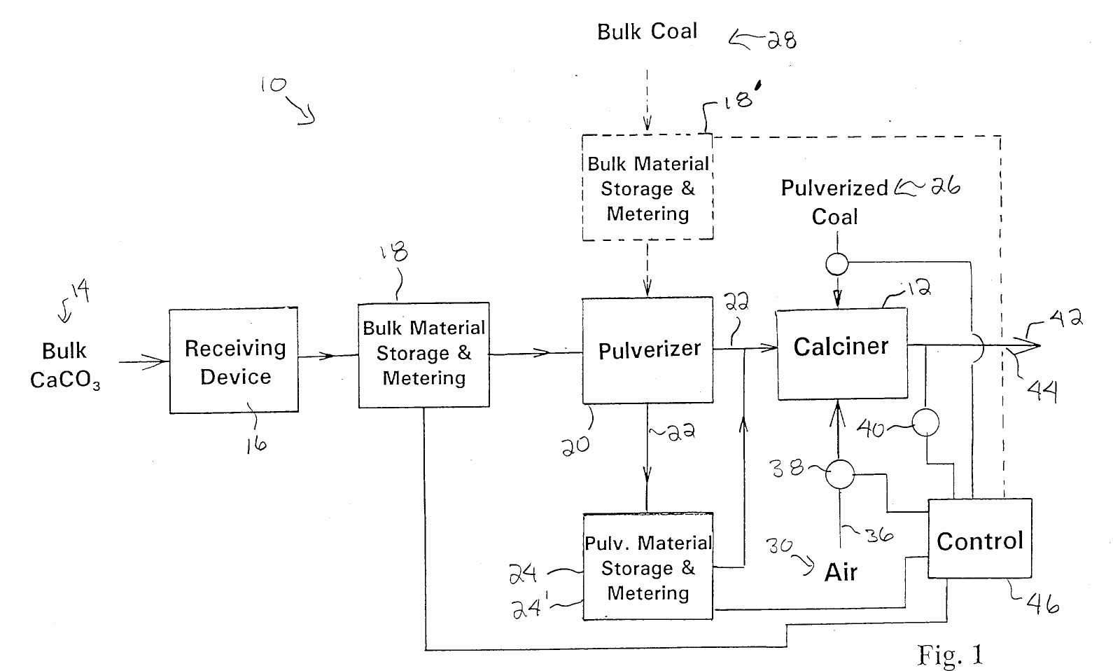

With reference to FIG. 1, a sorbent addition system 10 in accordance with the invention includes an external suspension calciner 12 fired with pulverized coal or any other fuel like oil or gas. Heat input for the calciner 12 is about 10 MMBtu/hr or about 0.5 tons/hr of coal. Bulk limestone 14 is received by a receiving device 16 (e.g. a conveyor) and deposited in a bulk material storage and metering device 18. The bulk limestone 14 is metered into a pulverizer 20, where it is pulverized to below 100 microns (typically, 95% less than 74 microns). The pulverized limestone 22 is deposited in a pulverized material storage and metering device 24. As required, the pulverized limestone 22 is metered into the calciner 12. Alternatively, pulverized limestone 22 may be fed directly from the pulverizer 20 to the calciner 12. Pulverized coal 26 is fed from the boiler pulverizer (not shown) into the calciner 12 to produce the heat required to convert the limestone 22 to lime. Alternatively, the bulk limestone 14 and bulk coal 28 may be separately metered to obtain the required ratio, ground in one pulverizer, and stored in a common pulverized material storage and metering device 24′. Bulk limestone receiving device 16, bulk material storage and metering device 18, pulverizer 20, and pulverized material storage and metering device 24 (as appropriate), define a limestone addition subsystem. The boiler pulverizer or alternatively bulk material storage and metering device 18′, pulverizer 20, and pulverized material storage and metering device 24 (as appropriate), define a fuel addition subsystem.

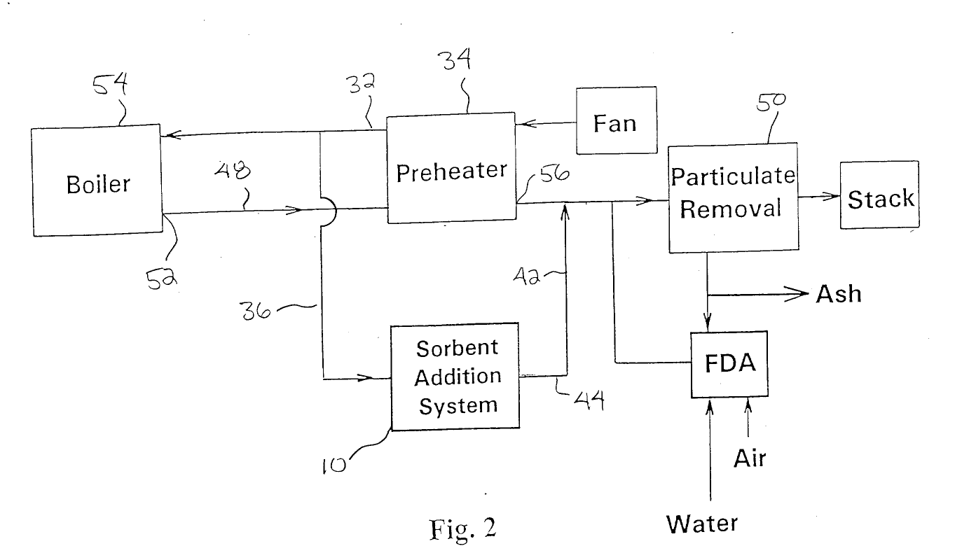

In one preferred embodiment, the calciner 12 is a refractory-lined duct having an upside-down U-shape to conserve plant space. However, various calciner designs of up-flow, down-flow and horizontal flow, either with refractory lining or other means of dealing with high calcination temperatures may also be employed. Air 30 for combustion in the calciner 12 is preferably supplied from the hot air outlet 32 of the air preheater 34 (FIGS. 2-4) via interconnecting ductwork 36, at a temperature of about 650° F. The air 30 is supplied at a velocity sufficiently high to transport the ground limestone 22 and sufficiently low to provide sufficient residence time for the degree of calcination desired. If sufficient positive pressure from the existing combustion air system and negative pressure from the sink where the lime will be injected exists, no additional fans would be required. If not, dependent on site specifics, an exhauster fan 38 may be located downstream of the mill, or at any other location to provide the necessary pressure head to overcome system resistances.

The sorbent addition system 10 includes one or more sensors 40 for monitoring the temperature of the calciner exhaust 42 (the “sorbent addition system exhaust stream”) in the injection duct 44 and a controller 46 which controls bulk material storage and metering device 18, bulk material storage and metering device 18′, pulverized material storage and metering device 24, common pulverized material storage and metering device 24′, and exhauster fan 38.

Operating temperatures in the calciner 12 are determined by site-specific economics, with higher temperatures resulting in a lower residence time and, hence, a smaller calcination reactor. Staged combustion may be considered to lower NOx in the calciner exhaust 42. Residence times required for the calcination process depend on the temperature profile and the limestone particle size. The degree of calcination the sorbent addition system 10 is designed to achieve depends on the overall site economics, as any uncalcined limestone introduced with the lime will not have a negative impact on the steam generator system.

The lime particles are discharged from the sorbent addition system 10 at a temperature above the calcination temperature of limestone (about 1,500° F.), into any location in the flue gas duct 48 before the dry scrubber 50 where the temperature is below 800° F. Discharge of the hot lime into a flue gas at a temperature below 800° F. quenches the lime and ensures that additional recarbonation or sulfation only occurs to a negligible extent. This results in the delivery of “virgin” lime to the FDA reactor that is extremely reactive. It also ensures that a majority of the lime (greater than 95%) is carried through to the back-end scrubber 50. The delivery of the majority of the lime after the economizer 52 ensures that no additional slagging/fouling occurs in the various heat recovery sections of the main boiler 54.

In a first embodiment (FIG. 2), the entire exhaust stream 42 from the calciner 12 (gases and solids) is exhausted into the flue gas duct 48 downstream of the cold flue gas outlet 56 of the air preheater 34. No recovery of heat from the sorbent addition system exhaust stream 42 is achieved in this embodiment. The high temperature of the sorbent addition system exhaust stream 42 produces a mean temperature rise in the main boiler flue gas reaching the scrubber 50 of about 25° F.

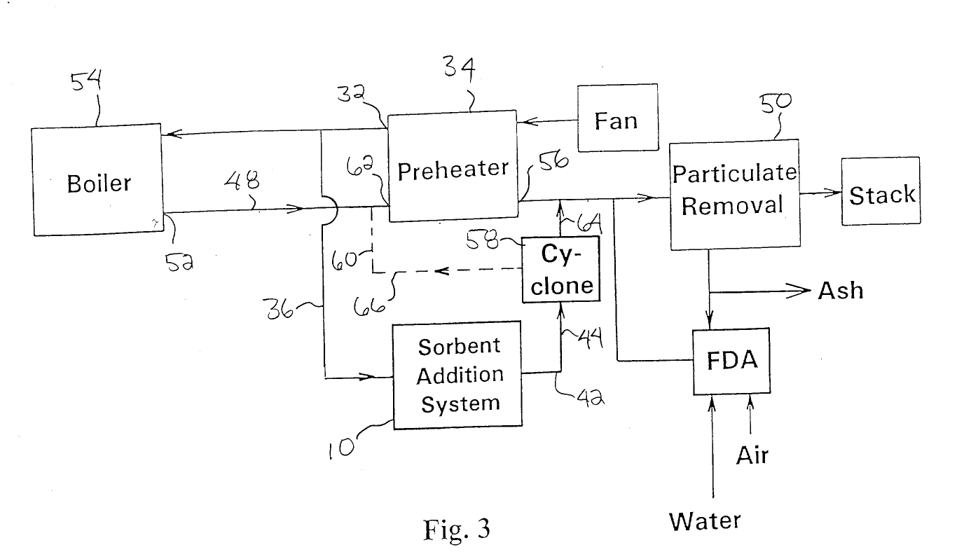

In a second embodiment (FIG. 3), a majority of the lime 64 (typically 95% or more) is separated from the sorbent addition system exhaust gases 60 by a particulate separator 58, for example a cyclone/core separator, and injected into the flue gas duct 48 downstream of the cold flue gas outlet 56 of the air preheater 34. The separated exhaust gases 60 are injected into the flue gas duct 48 between the boiler economizer 52 and the hot flue gas inlet 62 of the air preheater 34. The heat content in the exhaust gases 60 is substantially recovered by the air preheater 34, providing a more efficient overall system than the first embodiment. The unrecovered heat content of the lime 64 however, produces a mean temperature rise in the main boiler flue gas reaching the scrubber 50 of about 10° F.

Injecting only the exhaust gases 60 into the flue gas duct 48 between the boiler economizer 52 and the hot flue gas inlet 62 of the air preheater 34 also has another advantage. Although the majority of the lime 64 has been separated from the exhaust gases 60, a small portion of the lime 66 (typically about 5%, primarily the smaller particles of lime) remains entrained in the exhaust gases 60. The lime 66 in these gases 60 neutralizes at least a portion of any SO₃ that is generated in the boiler 54 due to the combustion of the coal, thus at least reducing the production of acid. The reduction in the acid produces operational advantages in the air preheater 34, including lower fouling, reduced pressure drop, less corrosion, and ease of cleaning, as well as reducing the likelihood that an SO₃ plume may be formed in the stack exhaust (by lowering condensable emissions).

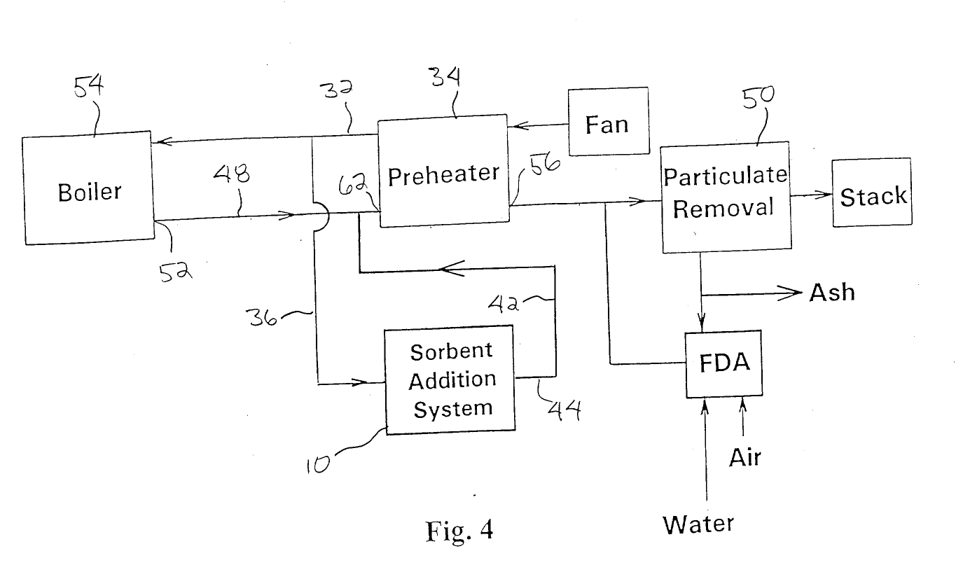

In a third embodiment (FIG. 4), the entire sorbent addition system exhaust stream 42 (gases and solids) is exhausted into the flue gas duct 48 between the boiler economizer 52 and the hot flue gas inlet 62 of the air preheater 34. Accordingly, the heat content of both the gases and the solids are substantially recovered by the air preheater 34, providing a more efficient overall system than the first and second embodiments. With the injection of all of the lime into the hot flue gas inlet 62 of the air preheater 34, any SO₃ generated by the boiler 54 will be absorbed thereby eliminating production of acid in the air preheater 34.

It should be appreciated that a sorbent addition system 10 in accordance with the invention will provide a significant operating cost savings by allowing the use of limestone 14 rather than “commercial” lime. In addition, the lime produced by the sorbent addition system 10 is a higher quality sorbent than “commercial” lime. The “virgin” sorbent produced by the system 10 is extremely reactive because it is produced in-situ, whereas the “commercial” lime is stored and delivered cold. The use of a more reactive sorbent will allow the consumption of less sorbent, providing for lower disposal costs for final ash product mix. Finally, retrofit of the sorbent addition system 10 requires minimal modification to the installed boiler economizer section 52.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A sorbent addition system for a steam generator system having a boiler, an air preheater, a scrubber, an air duct providing fluid communication between the air preheater and the boiler, a first flue gas duct providing fluid communication between the boiler and the air preheater, and a second flue gas duct providing fluid communication between the air preheater and the scrubber, the boiler producing a flue gas containing sulfur, the sorbent addition system comprising:
a calciner including a calciner exhaust adapted for providing fluid communication with a one of the first or second flue gas ducts;
a limestone addition subsystem in fluid communication with the calciner; and
a fuel addition subsystem in fluid communication with the calciner.

2. The sorbent addition system of claim 1 wherein the calciner comprises:
an upside-down U-shaped duct and
a refractory lining disposed within the duct.

3. The sorbent addition system of claim 1 further comprising an air inlet duct in fluid communication with the calciner, the air inlet duct being adapted for receiving a supply of hot combustion air from the air duct of the steam generator system.

4. The sorbent addition system of claim 1 wherein the fuel addition subsystem comprises
a pulverizer in fluid communication with the calciner and
a bulk coal storage and metering device in fluid communication with the pulverizer.

5. The sorbent addition system of claim 1 wherein the limestone addition subsystem comprises:
a pulverizer in fluid communication with the calciner and
a bulk limestone storage and metering device in fluid communication with the pulverizer.

6. The sorbent addition system of claim 5 wherein the limestone addition subsystem further comprises a bulk limestone receiving device for depositing the bulk limestone in the bulk limestone storage and metering device.

7. The sorbent addition system of claim 5 wherein the limestone addition subsystem further comprises a pulverized material storage and metering device disposed intermediate the pulverizer and the calciner.

8. The sorbent addition system of claim 7 wherein the fuel addition subsystem comprises a bulk coal storage and metering device in fluid communication with the pulverizer.

9. The sorbent addition system of claim 5 wherein the fuel addition subsystem comprises a bulk coal storage and metering device in fluid communication with the pulverizer.

10. The sorbent addition system of claim 1 further comprising a controller in electrical communication with the limestone addition subsystem and the fuel addition subsystem.

11. The sorbent addition system of claim 10 wherein the calciner also includes a temperature sensor for monitoring the temperature within the calciner exhaust, the controller being in electrical communication with the temperature sensor.

12. The sorbent addition system of claim 11 wherein the limestone addition subsystem comprises:
a pulverizer in fluid communication with the calciner and
a bulk limestone storage and metering device in fluid communication with the pulverizer and in electrical communication with the controller.

13. The sorbent addition system of claim 11 wherein the limestone addition subsystem further comprises a pulverized material storage and metering device disposed intermediate the pulverizer and the calciner, the pulverized material storage and metering device being in electrical communication with the controller.

14. The sorbent addition system of claim 13 wherein the fuel addition subsystem comprises a bulk coal storage and metering device in fluid communication with the pulverizer and in electrical communication with the controller.

15. The sorbent addition system of claim 14 further comprising:
an air inlet duct in fluid communication with the calciner, the air inlet duct being adapted for receiving a supply of hot combustion air from the air duct of the steam generator system, and
an exhauster fan disposed within the air inlet duct, the exhauster fan being in electrical communication with the controller.

16. The sorbent addition system of claim 12 wherein the fuel addition subsystem comprises a bulk coal storage and metering device in fluid communication with the pulverizer and in electrical communication with the controller.

17. The sorbent addition system of claim 16 further comprising:
an air inlet duct in fluid communication with the calciner, the air inlet duct being adapted for receiving a supply of hot combustion air from the air duct of the steam generator system, and
an exhauster fan disposed within the air inlet duct, the exhauster fan being in electrical communication with the controller.

18. The sorbent addition system of claim 1 further comprising a particulate separator device disposed in the calciner exhaust.

19. The sorbent addition system of claim 18 wherein the calciner exhaust is adapted for providing fluid communication with the first flue gas duct.

20. The sorbent addition system of claim 18 wherein the calciner exhaust is adapted for providing fluid communication with the second flue gas duct.

21. The sorbent addition system of claim 1 wherein the calciner exhaust is adapted for providing fluid communication with the first flue gas duct.

22. The sorbent addition system of claim 1 wherein the calciner exhaust is adapted for providing fluid communication with the second flue gas duct.

23. A sorbent addition system for a steam generator system having a boiler, an air preheater, a scrubber, an air duct providing fluid communication between the air preheater and the boiler, a first flue gas duct providing fluid communication between the boiler and the air preheater, and a second flue gas duct providing fluid communication between the air preheater and the scrubber, the boiler producing a flue gas containing sulfur, the sorbent addition system comprising:
a calciner including a calciner exhaust adapted for providing fluid communication with a one of the first or second flue gas ducts;
an air inlet duct in fluid communication with the calciner, the air inlet duct being adapted for receiving a supply of hot combustion air from the air duct;
a pulverizer in fluid communication with the calciner;
a first bulk material storage and metering device in fluid communication with the pulverizer;
a bulk limestone receiving device for depositing bulk limestone in the first bulk material storage and metering device;
a fuel addition subsystem in fluid communication with the calciner; and
a controller in electrical communication with the first bulk material storage and metering device and the fuel addition subsystem.

24. The sorbent addition system of claim 23 wherein the fuel addition subsystem comprises a bulk coal storage and metering device in fluid communication with the pulverizer and in electrical communication with the controller.

25. The sorbent addition system of claim 23 further comprising a pulverized material storage and metering device disposed intermediate the pulverizer and the calciner, the pulverized material storage and metering device being in electrical communication with the controller.

26. The sorbent addition system.of claim 23 wherein the calciner also includes a temperature sensor for monitoring the temperature within the calciner exhaust, the controller being in electrical communication with the temperature sensor.

27. The sorbent addition system of claim 23 further comprising an exhauster fan disposed within the air inlet duct, the exhauster fan being in electrical communication with the controller.

28. The sorbent addition system of claim 23 further comprising a particulate separator device disposed in the calciner exhaust.

29. The sorbent addition system of claim 28 wherein the calciner exhaust is adapted for providing fluid communication with the first flue gas duct.

30. The sorbent addition system of claim 28 wherein the calciner exhaust is adapted for providing fluid communication with the second flue gas duct.

31. The sorbent addition system of claim 23 wherein the calciner exhaust is adapted for providing fluid communication with the first flue gas duct.

32. The sorbent addition system of claim 23 wherein the calciner exhaust is adapted for providing fluid communication with the second flue gas duct.
